(19) United States
(12) Patent Application Publication
(10) Pub. No.: US 2011/0203710 A1
(43) Pub. Date: Aug. 25, 2011

(54) AUTOMATIC TIRE PRESSURE CONTROL AND MONITORING SYSTEM AND METHOD

(75) Inventors: Jesus Hinojosa, JR., Dallas, TX (US); Amado Crisolfo Coronado, Dallas, TX (US)

(73) Assignee: Mesa Digital, LLC

(21) Appl. No.: 13/016,469

(22) Filed: Jan. 28, 2011

Related U.S. Application Data
(60) Provisional application No. 61/307,532, filed on Feb. 24, 2010.

(51) Int. Cl. B60C 23/10; F17D 1/16

(52) U.S. Cl. 152/419; 137/14

(57) ABSTRACT

A dynamic tire-pressure control and monitoring method and system includes a pressure sensor, a control unit, and a built-in air compressor. The pressure sensor can be mounted on a wheel rim associated with a tire for detecting a tire pressure with respect to each wheel. The built-in compressor mounted on the wheel compresses air via an electronic valve from a reservoir to the tire when the tire pressure detected by the pressure sensor is below a predetermined value. The control unit regulates the sensed air pressure from the sensor and controls the operations of the compressor. The air pressure from the tire can also be released when a vehicle collision occurs in order to prevent explosion of the tire.

### CROSS-REFERENCE TO PROVISIONAL APPLICATION

This nonprovisional patent application claims the benefit under 35 U.S.C. §119(e) of U.S. Provisional Patent Application Ser. No. 61/307,532 filed on Feb. 24, 2010, entitled “Automatic Tire Pressure Control and Monitoring System and Method,” which is hereby incorporated by reference in its entirety.

### TECHNICAL FIELD

Embodiments are generally related to vehicle tire pressure control systems and methods. Embodiments are also related to pressure sensors. Embodiments are additionally related to built-in air compressors.

### BACKGROUND OF THE INVENTION

Tire inflation pressure and tire temperature are important safety parameters for automobiles, trucks, and other vehicles. Proper tire inflation pressure and temperature regulation are necessary to insure safe traction on slippery road conditions and to prevent excess wear on tires. Tire blowouts are usually the result of overloading a vehicle, impact damage, a massive cut that causes rapid air loss, or an unnoticed small puncture that permits the tire to slowly lose air over time until it fails. Such blowouts permit air to escape and prevent the tire from supporting the weight of the vehicle. Furthermore, tire pressure varies with the temperature of the air in the tire and can be consequently affected by vehicle speed, road surface, and ambient temperature, to name a few parameters.

Various tire pressure monitoring systems have been developed to provide information to a vehicle operator when air pressure within a tire drops below a predetermined threshold pressure value. The vehicle becomes increasingly hard to control as the tires become soft and, particularly in emergency situations, such reduced control may result in complete loss of control with resultant injury to the occupants of the vehicle and to other vehicles which may be involved in a collision. Conventionally, such deflated tires are changed with a spare tire situated somewhere on the vehicle before the vehicle can proceed. Such process of changing the deflated tire with the spare tire requires strength and can be a difficult task for some people and is time consuming.

Based on the foregoing, it is believed that a need exists for an improved, reliable, and energy efficient tire pressure control and monitoring system and method. A need also exists for an improved built-in air compressor for providing air to tires associated with a vehicle to regulate tire air pressure, as described in greater detail herein.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved tire pressure control and monitoring system and method.

It is another aspect of the disclosed embodiment to provide for an improved built-in air compressor for providing air to tires associated with a vehicle to regulate tire air pressure.

It is a further aspect of the disclosed embodiment to provide for an improved pressure sensor for monitoring tire pressure.

The aforementioned aspects and other objectives and advantages can now be achieved as described herein. A dynamic tire-pressure control and monitoring method and system is disclosed which includes a pressure sensor, a control unit, and a built-in air compressor. The pressure sensor can be mounted on a wheel rim associated with a tire for detecting a tire pressure with respect to each wheel. The built-in compressor mounted on the wheel compresses air via an electronic valve from a reservoir to the tire when the tire pressure detected by the pressure sensor is below a predetermined value. The control unit regulates the sensed air pressure from the sensor and controls the operations of the compressor. The air pressure from the tire can also be released via the valve when a vehicle collision occurs in order to prevent explosion of the tire.

The reservoir temporarily retains the air compressed by the compressor and the valve located on the wheel regulates the air pressure supplied to and discharged from the tire. A power source associated with the control unit provides power to the pressure sensor, the control unit, and the compressor. Optionally, the compressor can release foam into the tire in order to control the pressure loss in the tire. The tire safety monitoring system compensates fluctuations and automatically adjusts the tire pressure for optimum safety and performance.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a block diagram of an automatic tire pressure control and monitoring system, in accordance with the disclosed embodiments;

FIG. 2 illustrates a perspective view of the tire pressure control and monitoring system, in accordance with the disclosed embodiments; and

FIG. 3 illustrates a high level flow chart of operations illustrating logical operational steps of a method for monitoring and controlling tire pressure, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

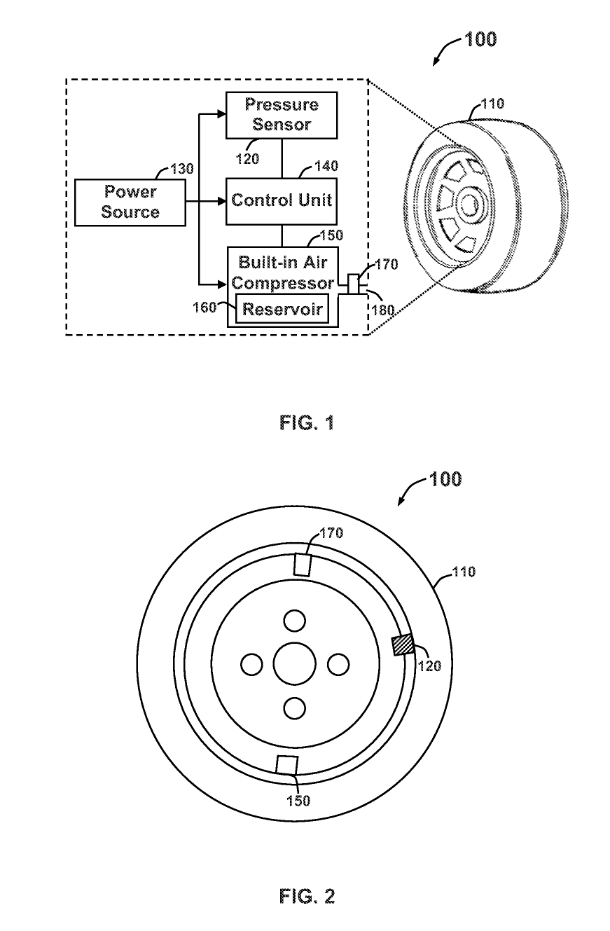

FIG. 1 illustrates a block diagram of an automatic tire pressure control and monitoring system 100, in accordance with the disclosed embodiments. The system 100 can be employed to monitor and control air pressure in tires associated with a vehicle such as, for example, trucks, trailers, buses, motorized recreational vehicles, recreational trailers, cube vans, vans, mini-vans, and the like. The system 100 generally includes a pressure sensor 120, a built-in air compressor 150, and a control unit 140 electrically configured in association with a power source 130 located on the tire 110 associated with the vehicle. The system 100 further includes a valve 170 associated with the compressor 150 for opening or closing an air passage 180 that connects the compressor 150.

The compressor 150 provides compressed air with a specified tire pressure from a reservoir 160 associated with the compressor 150 into the tire 110 at each wheel when a loss of pressure in the tire 110 detected by the pressure sensor 120. The air pressure from the tire 110 can also be released when a vehicle collision occurs in order to prevent explosion of the tire 110. The reservoir 160 temporarily retains the air compressed by the compressor 150 and the valve 170 supplies and discharges air to and from the tire 110. The control unit 140 regulates the pressure in the tire 110 utilizing the pressure signal generated by the pressure sensor 120 and controls the operations of the compressor 150. The power source 130 associated with the system 100 can provide power to the pressure sensor 120, the control unit 140, and the compressor 150.

The pressure valve 170 can be an electromagnetic valve for regulating the tire pressure at each wheel, depending upon design considerations. The pressure valve 170 can be opened when the compressor 150 is operating to introduce air into the tire 110 to increase the tire pressure. The pressure valve 170 can be opened to discharge air from the tire 110 to reduce the tire pressure. The tire pressure sensor 120 can be a semiconductor sensor. The tire pressure sensor 120 detects the tire pressure and transmits a signal that indicates the tire pressure to the control unit 140. The pressure sensor 120 may possess a piezoelectric sensor that generates an output voltage based on a magnitude of the tire pressure depending upon design considerations. It can be appreciated that other types of pressure sensors may be employed in place of the suggested sensor. Each tire pressure sensor 120 periodically detects the tire pressure in the corresponding tire and transmits the detected tire pressure to the control unit 140. The detected tire pressure is used in state monitoring by the control unit 140.

FIG. 2 illustrates a perspective view of the automatic tire pressure control and monitoring system 100, in accordance with the disclosed embodiments. Note that in FIGS. 1-3, identical or similar blocks are generally indicated by identical reference numerals. The pressure valve 170 can be opened when a loss of pressure in the tire is detected by the sensor 120. The high-pressure air can be discharged from the compressor 150 into the tire 110 of the corresponding wheel via the valve 170 in order to increase the tire pressure. The air pressure from the tire 110 can also be released in order to prevent explosion of the tire 110. The compressor 150 can also optionally release foam into the tire 110 in order to control the pressure loss in the tire 110. The system 100 can compensate the fluctuations in the pressure and temperature of the vehicle tires 110 and automatically adjusts the tire pressure.

The system 100 can provide the vehicle operator with a convenient means to automatically regulate the pressure of the vehicle tire 110 for optimum safety and performance. As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

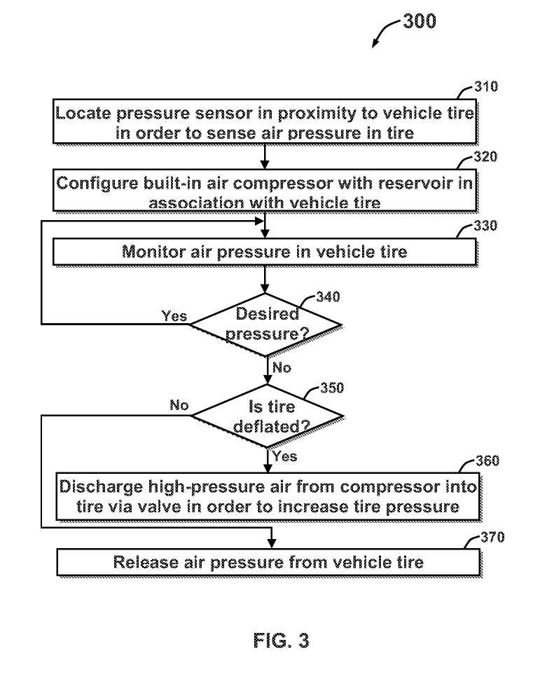

FIG. 3 illustrates a high level flow chart of operations illustrating logical operational steps of a method 300 for monitoring and controlling air pressure in the tire 110 associated with the vehicle, in accordance with the disclosed embodiments. The pressure sensor 120 can be located in proximity to vehicle tire 110 in order to sense air pressure in the tire 110, as indicated at block 310. The built-in air compressor 150 with the reservoir 160 can be configured in association with tire 110, as depicted at block 320. The air pressure in the tire 110 can be monitored by the pressure sensor 120, as illustrated at block 330. A determination can be made whether the tire pressure is normal, as indicated at block 340.

If the tire pressure is abnormal, another determination can be made whether the tire 110 is deflated, as depicted at block 350. If the tire pressure is deflated, the high-pressure air can be discharged from the compressor 150 into the tire 110 via the valve 170 in order to increase the tire pressure, as illustrated at block 360. If the tire pressure is inflated, the air can be released from the tire 110 via the valve 170 to avoid explosion, as illustrated at block 370. The severe tire wear caused due to under-inflation of the tire can be prevented by automatically pumping compressed air into the tire 110. It is believed that by utilizing the system and method described herein, the vehicle safety, performance, and fuel economy can be improved by maintaining the desired pressure in the vehicle tire.

Based on the foregoing, it can be appreciated that a tire pressure control system is disclosed, which includes in some embodiments, a pressure sensor mounted on a wheel rim associated with a tire, wherein the pressure sensor detects a tire pressure with respect to the tire, an integrated air compressor mounted on the wheel, wherein the integrated air compressor automatically compresses air via an electronic valve associated with an air flow path to the tire when the tire pressure detected by the pressure sensor is below a predetermined threshold, and a control unit that regulates sensed air pressure received from the pressure sensor and controls operations of the integrated air compressor. In general, the valve can release air pressure from the tire when a vehicle collision occurs in order to prevent an explosion of the tire. In some embodiments, the integrated air compressor can automatically release foam into the tire in order to control a pressure loss in the tire if the pressure sensor detects the pressure below a particular threshold. Additionally, in some embodiments, a reservoir can be provided, which is associated with the integrated air compressor that temporarily retains air compressed by the integrated air compressor. Additionally, in some embodiments, the valve releases air pressure from the tire when a vehicle collision occurs in order to prevent an explosion of the tire; and the integrated air compressor automatically releases foam into the tire in order to control a pressure loss in the tire if the pressure sensor detects the pressure below a particular threshold.

In other embodiments, the tire pressure control system can be configured to include a pressure sensor mounted on a wheel rim associated with a tire, wherein the pressure sensor detects a tire pressure with respect to the tire, an integrated air compressor mounted on the wheel, wherein the integrated air compressor automatically compresses air via an electronic valve associated with an air flow path to the tire when the tire pressure detected by the pressure sensor is below a predetermined threshold, and a control unit that regulates sensed air pressure received from the pressure sensor and controls operations of the integrated air compressor, wherein the valve releases air pressure from the tire when a vehicle collision occurs in order to prevent an explosion of the tire. The integrated air compressor automatically releases foam into the tire in order to control a pressure loss in the tire if the pressure sensor detects the pressure below a particular threshold. In such embodiments, a reservoir can be associated with the integrated air compressor that temporarily retains air compressed by the integrated air compressor.

In still other embodiments, a method can be provided for controlling tire pressure. Such a method can include the steps of detecting a tire pressure with respect to each wheel via a pressure sensor mounted on a wheel rim associated with a vehicle; automatically compressing air from a built-in compressor mounted on the wheel via an electronic valve associated with an air flow path to the tire, when the tire pressure detected by the pressure sensor is below a predetermined value; and releasing air pressure via the valve from the when a vehicle collision occurs in order to prevent explosion with respect to the tire. Additional steps can include releasing foam from the compressor into the tire in order to control a pressure loss in the tire.

In yet other embodiments, a tire pressure control method can be provided, which includes the steps of mounting a pressure sensor on a wheel rim associated with a tire; configuring the pressure sensor to detect a tire pressure with respect to the tire; locating an integrated air compressor on the wheel; configuring the integrated air compressor to automatically compress air via an electronic valve associated with an air flow path to the tire when the tire pressure detected by the pressure sensor is below a predetermined threshold; regulating, via a control unit, sensed air pressure received from the pressure sensor; and controlling, via the control unit, operations of the integrated air compressor. In such a method, the valve can release air pressure from the tire when a vehicle collision occurs in order to prevent an explosion of the tire. Additionally, in the context of such a method, the integrated air compressor can automatically release foam into the tire in order to control a pressure loss in the tire if the pressure sensor detects the pressure below a particular threshold.

Also, in such a method a step can be implemented for providing a reservoir that is with the integrated air compressor and which temporarily retains air compressed by the integrated air compressor. Additionally, in such a method, the valve can release air pressure from the tire when a vehicle collision occurs in order to prevent an explosion of the tire; and the integrated air compressor automatically can release foam into the tire in order to control a pressure loss in the tire if the pressure sensor detects the pressure below a particular threshold.

Additionally, a reservoir can be associated with the integrated air compressor to temporarily retain air compressed by the integrated air compressor. A step can also be implemented for associating a reservoir with the integrated air compressor to temporarily retain air compressed by the integrated air compressor. In still other embodiments of such a method, the valve can release air pressure from the tire when a vehicle collision occurs in order to prevent an explosion of the tire.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A tire pressure control system, comprising:
a pressure sensor mounted on a wheel rim associated with a tire, wherein said pressure sensor detects a tire pressure with respect to said tire,
an integrated air compressor mounted on said wheel, wherein said integrated air compressor automatically compresses air via an electronic valve associated with an air flow path to said tire when said tire pressure detected by said pressure sensor is below a predetermined threshold; and
a control unit that regulates sensed air pressure received from said pressure sensor and controls operations of said integrated air compressor.

2. The system of claim 1 wherein said valve releases air pressure from said tire when a vehicle collision occurs in order to prevent an explosion of said tire.

3. The system of claim 1 wherein said integrated air compressor automatically releases foam into said tire in order to control a pressure loss in said tire if said pressure sensor detects said pressure below a particular threshold.

4. The system of claim 1 further comprising a reservoir associated with said integrated air compressor that temporarily retains air compressed by said integrated air compressor.

5. The system of claim 1 wherein:
said valve releases air pressure from said tire when a vehicle collision occurs in order to prevent an explosion of said tire; and
said integrated air compressor automatically releases foam into said tire in order to control a pressure loss in said tire if said pressure sensor detects said pressure below a particular threshold.

6. The system of claim 5 further comprising a reservoir associated with said integrated air compressor that temporarily retains air compressed by said integrated air compressor.

7. The system of claim 1 further comprising a reservoir associated with said integrated air compressor that temporarily retains air compressed by said integrated air compressor, wherein said valve releases air pressure from said tire when a vehicle collision occurs in order to prevent an explosion of said tire.

8. A tire pressure control system, comprising:
a pressure sensor mounted on a wheel rim associated with a tire, wherein said pressure sensor detects a tire pressure with respect to said tire;
an integrated air compressor mounted on said wheel, wherein said integrated air compressor automatically compresses air via an electronic valve associated with an air flow path to said tire when said tire pressure detected by said pressure sensor is below a predetermined threshold; and
a control unit that regulates sensed air pressure received from said pressure sensor and controls operations of said integrated air compressor, wherein said valve releases air pressure from said tire when a vehicle collision occurs in order to prevent an explosion of said tire.

9. The system of claim 8 wherein said integrated air compressor automatically releases foam into said tire in order to control a pressure loss in said tire if said pressure sensor detects said pressure below a particular threshold.

10. The system of claim 8 further comprising a reservoir associated with said integrated air compressor that temporarily retains air compressed by said integrated air compressor.

11. A method for controlling tire pressure, said method comprising:
detecting a tire pressure with respect to each wheel via a pressure sensor mounted on a wheel rim associated with a vehicle;
automatically compressing air from a built-in compressor mounted on said wheel via an electronic valve associated with an air flow path to said tire when said tire pressure detected by said pressure sensor is below a predetermined value; and
releasing air pressure via said valve from said tire when a vehicle collision occurs in order to prevent explosion with respect to said tire.

12. The method of claim 5 further comprising releasing foam from said compressor into said tire in order to control a pressure loss in said tire.

13. A tire pressure control method, said method comprising:
mounting a pressure sensor on a wheel rim associated with a tire;
configuring said pressure sensor to detect a tire pressure with respect to said lire;
configuring said integrated air compressor to automatically compress air via an electronic valve associated with an air flow path to said tire when said tire pressure detected by said pressure sensor is below a predetermined threshold;
regulating, via a control unit, sensed air pressure received from said pressure sensor; and
controlling, via said control unit, operations of said integrated air compressor.

14. The method of claim 13 wherein said valve releases air pressure from said tire when a vehicle collision occurs in order to prevent an explosion of said tire.

15. The method of claim 13 wherein said integrated air compressor automatically releases foam into said tire in order to control a pressure loss in said tire if said pressure sensor detects said pressure below a particular threshold.

16. The method of claim 13 further comprising providing a reservoir that is with said integrated air compressor and which temporarily retains air compressed by said integrated air compressor.

17. The method of claim 13 wherein:
said valve releases air pressure from said tire when a vehicle collision occurs in order to prevent an explosion of said tire; and
said integrated air compressor automatically releases foam into said tire in order to control a pressure loss in said tire if said pressure sensor detects said pressure below a particular threshold.

18. The method of claim 17 further comprising associating a reservoir with said integrated air compressor that temporarily retains air compressed by said integrated air compressor.

19. The method of claim 14 further comprising associating a reservoir with said integrated air compressor to temporarily retain air compressed by said integrated air compressor.

20. The method of claim 19 wherein said valve releases air pressure from said tire when a vehicle collision occurs in order to prevent an explosion of said tire.
